(19) United States
(12) Patent Application Publication
(10) Pub. No.: US 2014/0370336 A1
(43) Pub. Date: Dec. 18, 2014

(54) Battery having a Protection from Adjacent Cells in Case of Discharge of a Battery Cell

(71) Applicants: Alexander Reitzle, Neu-Ulm (DE); Ulrich Zimmermann, Hessigheim (DE)

(72) Inventors: Alexander Reitzle, Neu-Ulm (DE); Ulrich Zimmermann, Hessigheim (DE)

(73) Assignees: Samsung SDI Co., Ltd., Yongin-si, Gyeonggi-do (DE); Robert Bosch GmbH, Stuttgart (DE)

(21) Appl. No.: 13/819,422

(22) PCT Filed: Jul. 1, 2011
(86) PCT No.: PCT/EP2011/061094

§ 371 Date: May 20, 2013

(30) Foreign Application Priority Data
Aug. 31, 2010 (DE) 10 2010 039 976.0

(51) Int. Cl. H01M 2/12

(52) U.S. Cl. CPC H01M 2/1252; H01M 2/1241
USPC 429/56

(57) ABSTRACT

A battery comprises a housing and a plurality of battery cells arranged in the housing. Each battery cell has at least one discharge valve. The battery further comprises a discharge pipe system for discharging gases released from one, a plurality of or all discharge valves of the battery cells. The discharge pipe system according to the disclosure has a plurality of separate connections for receiving the released gases and a common discharge guide into which the separate connections open and via which the released gases can be discharged out of the housing. The battery is characterized in that a protective film is arranged between the discharge valves of the battery cells and the separate connections of the discharge pipe system so that direct contact of the battery cells to the gases in the discharge pipe system is prevented.

The present invention relates to a battery which is embodied in such a way that adjacent battery cells are protected from the harmful effects of the gases released when a battery cell is relieved.

### PRIOR ART

Battery cells that are customarily used in batteries, in particular in lithium-ion batteries, have a safety or blowoff valve which opens when an excessive pressure develops within the battery cell, due to overheating and evaporation of the electrolyte for example, and allows material, generally in the form of gases, to escape from the cell. An explosion of the battery cell body is thereby avoided. The gases released during what is known as the relief of a battery cell are discharged from the battery housing via a discharge tube system in order to prevent contact between the gases, some of which are highly reactive, and other components of the battery. For this purpose, the general practice is for all battery cells of a battery to be connected to a common discharge tube system.

If relief occurs at one battery cell of a battery, the gases released initially enter the discharge tube system of the battery and, from there, can enter into contact with all the other battery cells connected to the discharge tube system of the battery and contaminate and/or damage these essentially uninvolved battery cells. After relief, even of just one single battery cell, it is thus necessary to replace all the battery cells and the discharge tube system of a battery. This gives rise to a lot of repair work and associated high costs.

### DISCLOSURE OF THE INVENTION

According to the invention, a battery is made available, comprising: a housing; a plurality of battery cells arranged in the housing, wherein each battery cell has at least one blowoff valve; and a discharge tube system for discharging gases released from one, a plurality of or all the blowoff valves of the battery cells, wherein the discharge tube system has a plurality of separate connections for receiving the gases released and a common discharge conduit, into which the separate connections open and via which the gases released can be discharged from the housing. The battery according to the invention is characterized in that a protective film is arranged between the blowoff valves of the battery cells and the separate connections of the discharge tube system, thus substantially preventing direct contact between the battery cells and gases in the discharge tube system.

The battery according to the invention has the advantage that those components of the battery which are not directly affected when a battery cell of the battery is relieved are protected from contact with the gases released. Contact between gases released into the discharge tube system during relief and other, unrelieved battery cells is prevented by the protective film. There is no contamination or impairment of the other, uninvolved battery cells of the battery. The protective film can simply be removed and replaced. This makes it possible to limit the expenditure on repairs to the selective replacement of the relieved battery cell(s) of the battery and of the protective film, while the other battery cells of the battery do not have to be exchanged or cleaned. This also limits the amount of waste which arises when remedying the consequences of the relief of a battery cell of a battery and which has to be disposed of, possibly giving rise to costs. This is of great benefit in the case of lithium-ion batteries in particular and, in that case, especially with high-capacity lithium-ion batteries for use in the motor vehicle sector.

The battery according to the invention comprises a plurality of battery cells arranged in a common housing, which are preferably connected together in a suitable manner. The battery according to the invention always has a plurality of battery cells, which are combined to form a functional unit. The battery can comprise a plurality of individual battery cells or one or more battery modules, with the modules each having a plurality of battery cells connected in a suitable manner. For this purpose, the individual battery cells of the battery can be connected to one another in an electrically conductive manner in such a way that they are arranged to give desired battery-module or battery architectures.

In this context, a “battery cell” is understood to mean an electrochemical energy storage device which can store energy by means of electrochemical processes and make it available again when required. In principle, battery cells of any accumulator or battery cell type can be used in the battery according to the invention. The battery preferably comprises battery cells of the lithium-ion cell type, in particular of the Li-ion lithium-ion accumulator, LiPo lithium-polymer accumulator, LiFe lithium-metal accumulator, Li—Mn lithium-manganese accumulator, LiFePO₄ lithium iron phosphate accumulator, LiTi lithium titanate accumulator.

The battery according to the invention is preferably a lithium-ion battery, in particular a high-capacity lithium-ion battery, particularly preferably a battery, e.g. a lithium-ion battery, with a nominal capacity of ≧2 Ah, preferably of ≧3 Ah.

The battery according to the invention can have additional components, e.g. a battery management system (BMS) for open-loop or closed-loop control of the battery behavior.

The battery according to the invention has a common housing, in which all the battery cells or modules of the battery are arranged. In this context, the term “housing” is intended to mean a device which has an interior suitable for accommodating a plurality of battery cells. A housing can be permanently or temporarily open to the environment in one or two directions. As a preferred option, the housing delimits the battery cells it contains with respect to the environment completely in all directions, and the housing can have access features that can be closed, such as doors or covers. The term “housing” cannot be taken to mean the immediate cell jacket which separates the electrochemical constituents of an individual cell directly from the environment. The housing can preferably be produced from a material which includes or consists of a metal, a metal sheet or a ceramic. As a particularly preferred option, the housing can be produced from a material which contains or consists of aluminum.

In the battery according to the invention, each battery cell has at least one blowoff valve. The term “blowoff valve” is intended to mean a valve which is closed during the normal operation of the battery and closes off the interior of a battery cell from the environment. When a certain interior pressure in the battery cell is exceeded, the blowoff valve opens, and material can be released from the interior of the cell. The material released is generally in the form of gas. The blowoff valve is thus a safety valve, which is closed during the normal operation of the battery and opens only in stress situations in order, for example, to prevent the battery cell from exploding. Here, the blowoff valve can be designed as a pressure relief valve, e.g. as a bursting valve or bursting disk.

In order to remove from the housing of the battery the gases released from one or more blowoff valves of the battery cells, the battery according to the invention has a discharge tube system. This discharge tube system connects the blowoff valves of the battery cells to an outlet from the housing in a gastight and gas-conducting manner in such a way that gas which is released when the battery cells are relieved can be transferred via the blowoff valves to the discharge tube system and then discharged from the housing. For this purpose, the discharge tube system has a plurality of separate connections, which serve to receive gases released via the blowoff valves directly from the blowoff valves and to feed them to a common discharge conduit, via which the gases released are discharged from the housing. A separate connection has two opposite ends, wherein one end is mounted over a blowoff valve and is connected in a gastight and gas-conducting manner by the latter to a battery cell, ensuring that gas released from the blowoff valve is transferred directly into the separate connection. The other end is connected in a gastight and gas conducting manner to the common discharge conduit, thus enabling gas received via the separate connection to be fed to the common discharge conduit and, via the latter, to be carried out of the housing of the battery. The discharge tube system can provide a dedicated separate connection for each battery cell or even for each blowoff valve, or a separate connection can be designed and arranged in such a way that the gas released from a plurality of battery cells is received by a single separate connection. All the separate connections of the battery according to the invention preferably open into a single common discharge conduit. The discharge tube system of the battery according to the invention can also have more than one common discharge conduit, with some of the separate connections opening into a first common discharge conduit and others of the separate connections opening into a second common discharge conduit.

The battery according to the invention is characterized in that a protective film is arranged between the blowoff valves of the battery cells and the separate connections of the discharge tube system. This protective film is embodied and arranged in such a way that direct contact between the battery cells and gases in the discharge tube system is thereby substantially prevented. This ensures that gases released into the discharge tube system by a blowoff valve of one battery cell are not able to contaminate or damage component parts of the other, unrelieved battery cells of the battery. The gases released remain in the discharge tube system and can escape via the latter from the housing without adversely affecting the other battery cells.

The battery according to the invention preferably has a dedicated separate protective film between each battery module, each group of battery cells, each battery cell and/or each blowoff valve and the corresponding separate connection of the discharge tube system, said connection being connected gastightly thereto. The advantage of this embodiment is, in particular, that, after the relief of a battery cell, only the protective films which are actually contaminated or damaged have to be replaced.

The protective film is preferably arranged in such a way that the protective film rests on a surface of the battery cell and separates it substantially in a gastight manner from gases in the discharge tube system. In particular, in this case the protective film can rest substantially fully on a surface of the battery cell which is occupied by the corresponding separate receptacle of the discharge tube system. The gastight closure of the protective film with the separate receptacle can be achieved, for example, by the fact that the protective film is pressed against the surface of the battery cell by the shoulder of the separate connection of the discharge tube system. In this case, the contact pressure is chosen in such a way that substantially gastight closure is achieved. By virtue of the fact that the protective film rests on a surface of the battery cell, a pressure surge in the discharge tube system caused, for example, by the relief of one battery cell of the battery, cannot lead to the protective film over the other, unrelieved battery cells of the battery from tearing open or being damaged.

The protective film is embodied and dimensioned in such a way that it in each case covers the blowoff valves of the battery cells. The protective film has a thickness which is sufficient to allow substantially gastight closure with the corresponding separate connection and which, at the same time, ensures that the protective film tears open when a battery cell is relieved via the blowoff valve thereof, allowing the gases released to pass out of the respective battery cell into the discharge tube system via the blowoff valve. The protective film is preferably produced from a material which is substantially resistant to the gases released when a battery cell is relieved into the discharge tube. As a particularly preferred option, the protective film contains polytetrafluoroethylene (referred to as PTFE or polytetrafluoroethene or Teflon®) or is composed of the latter.

In addition, the battery according to the invention can have further means for protecting unrelieved battery cells. For example, one or more valves can additionally be arranged in the discharge tube system. These additional valves are embodied and arranged in such a way that the gases released are carried directionally out of the housing toward an outlet from the battery cells involved when one or more blowoff valves are relieved. In this case, the gas flow is guided by means of suitable valves and a suitable arrangement of the valves in such a way that uninvolved, unrelieved battery cells substantially do not come into contact with the gas released, which is in the discharge tube system. The valves prevent the movement of the gases released in the direction of the uninvolved battery cells, while the movement of the gases released through the discharge tube system is allowed in the direction of the outlet from the housing of the battery according to the invention. For this purpose, said additional valves can be designed as directional control valves, preferably as 2/2-way valves, which allow gases to pass through only in one direction and are substantially gastight in the opposite direction. An additional valve of this kind can be embodied as a duckbill valve, for example. In this case, one, a plurality of or all the separate connections of the battery according to the invention can have an additional valve of this kind. As an alternative or in addition, the common discharge conduit of the discharge tube system can also have one or more additional valves of this kind.

The routing of the tubes in the discharge tube system is preferably configured in such a way that the pressure surge when a battery cell is relieved is always guided in the direction of an outlet out of the housing. The pressure on the additional valves and hence the requirements on the leaktightness thereof are thereby reduced.

The present invention also comprises a motor vehicle which contains a battery according to the invention. The aim here is not that the motor vehicle and the battery should form a structural unit but that the motor vehicle and the battery according to the invention should be functionally in contact in such a way that the battery can perform its function during the operation of the motor vehicle. In this context, the term “motor vehicle” is intended to mean all driven vehicles which have a battery for supplying power to at least one component of the motor vehicle, irrespective of what type of drive these motor vehicles have. In particular, the term “motor vehicle” includes electric hybrid vehicles (HEV), plug-in hybrid vehicles (PHEV), electric vehicles (EV), fuel cell vehicles and all vehicles which use a battery for at least partial supply with electric energy.

### DRAWINGS

Illustrative embodiments of the invention are explained in greater detail by means of the drawings and of the following description. In the drawings:

FIG. 1 shows a schematic illustration of a first embodiment of the battery according to the invention, having a protective film, wherein a side view is illustrated in FIG. 1,

FIG. 2 shows a schematic illustration of a first embodiment of the battery according to the invention, having a protective film, wherein a plan view is illustrated in FIGS. 2, and

FIG. 3 shows a schematic illustration of a second embodiment of the battery according to the invention, wherein additional valves are arranged in the discharge tube system.

### EMBODIMENTS OF THE INVENTION

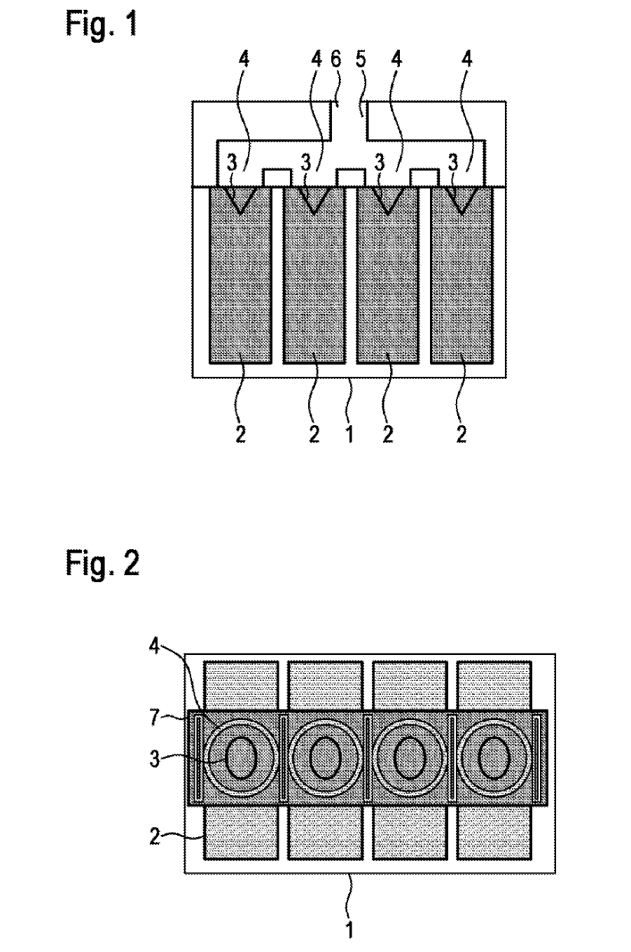

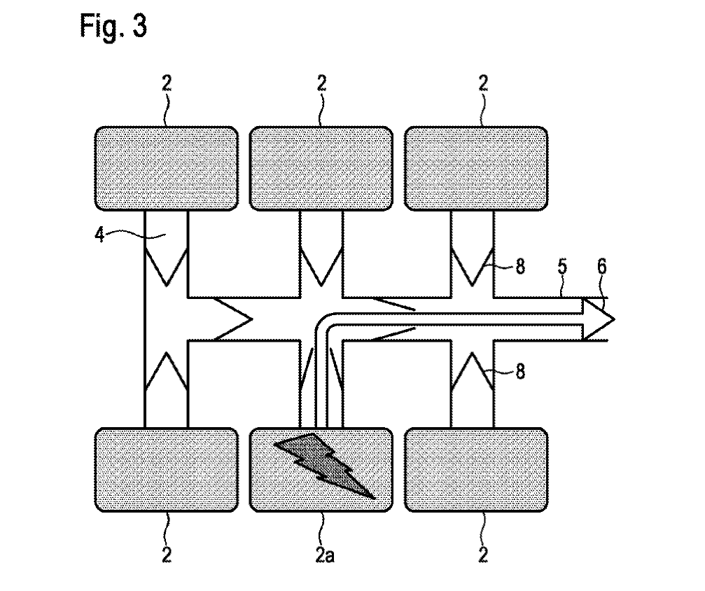

A battery according to the invention is illustrated schematically in FIGS. 1 and 2. In FIG. 1, the battery is illustrated in a side view, while FIG. 2 shows the same embodiment in a plan view. A plurality of battery cells 2 is arranged in the housing 1, wherein each battery cell 2 has at least one blowoff valve 3. Respective separate connections 4 are mounted over the blowoff valves 3 of the battery cells 2, and these connections are capable of receiving gases released when the battery cells 2 are relieved through the respective blowoff valves 3 and of guiding them to the common discharge conduit 5 of the discharge tube system. Via the common discharge conduit 5 of the discharge tube system, gases released can be fed to an outlet 6 in the housing 1 and removed from the interior of the battery via said outlet. The battery according to the invention is characterized in that a protective film 7 is arranged between the blowoff valves 3 of the battery cells 2 and the respective separate connections 4 of the discharge tube system.

This protective film 7 prevents direct contact between the blowoff valves 3 and gases in the discharge tube system and thus protects unrelieved battery cells 2 when one or more battery cells of the battery according to the invention are relieved.

FIG. 3 shows a development of the battery according to the invention from FIGS. 1 and 2, wherein the battery now has valves 8 in addition, these being arranged in the discharge tube system in such a way that the gas released when the blowoff valve of one battery cell 2a is relieved is guided in a directional manner (see arrow) toward the outlet 6 out of the housing 1 of the battery according to the invention and, in the process, substantially does not come into contact with a surface of other, unrelieved battery cells 2 of the battery. Through the use of two independent systems, the probability of contamination of uninvolved battery cells 2 with gases released during the relief of one battery cell 2a is significantly reduced.

1. A battery comprising:
a housing;
a plurality of battery cells arranged in the housing, each battery cell of the plurality of battery cells including at least one blowoff valve;
a discharge tube system configured to discharge gases released from one, a plurality of or all the blowoff valves of the battery cells, the discharge tube system including a plurality of separate connections configured to receive the gases released and a common discharge conduit, into which the separate connections open and via which the gases released are configured to be discharged from the housing; and
a protective film arranged between the blowoff valves of the battery cells and the separate connections of the discharge tube system, and configured to prevent direct contact between the battery cells and gases in the discharge tube system.

2. The battery as claimed in claim 1, wherein the battery is a lithium-ion battery.

3. The battery as claimed in claim 1, wherein the discharge tube system includes a separate connection for each battery cell of the plurality of battery cells.

4. The battery as claimed in claim 3, wherein a separate protective film is arranged between each battery cell of the plurality of battery cells and the corresponding separate connection of the discharge tube system.

5. The battery as claimed in claim 1, wherein the protective film rests on a surface of the battery cell.

6. The battery as claimed in claim 5, wherein the protective film is pressed against the surface of the battery cell by a separate connection of the discharge tube system.

7. The battery as claimed in claim 1, wherein the protective film is substantially resistant to the gases released when a battery cell of the plurality of battery cells is relieved into the discharge tube system.

8. The battery as claimed in claim 1, wherein the protective film contains polytetrafluoroethylene or is composed of the latter.

9. The battery as claimed in claim 1, wherein the protective film is configured to tear when a battery cell is relieved via the blowoff valve thereof.

10. The battery as claimed in claim 1, wherein one or more valves are additionally arranged in the discharge tube system in such a way that the gases released are carried directionally out of the housing toward an outlet when one or more blowoff valves are relieved.

11. The battery as claimed in claim 10, wherein one, a plurality of or all the separate connections of the discharge tube system has/have an additional valve.

12. The battery as claimed in claim 10, wherein the common discharge conduit of the discharge tube system has one or more additional valves.

13. The battery as claimed in claim 10, wherein the additional valves are configured as directional control valves.

14. The battery as claimed in claim 10, wherein the additional valves in the discharge tube system are embodied and arranged in such a way that the gas released into the discharge tube system when one or more blowoff valves of one battery cell are relieved cannot come into contact with a surface of the other, unrelieved battery cells of the battery.

15. A motor vehicle comprising:
a battery including (i) a housing, (ii) a plurality of battery cells arranged in the housing, each battery cell of the plurality of battery cells including at least one blowoff valve, (iii) a discharge tube system configured to discharge gases released from one, a plurality of or all the blowoff valves of the battery cells, the discharge tube system including a plurality of separate connections configured to receive the gases released and a common discharge conduit, into which the separate connections open and via which the gases released are configured to be discharged from the housing, and (iv) a protective film arranged between the blowoff valves of the battery cells and the separate connections of the discharge tube system, and configured to prevent direct contact between the battery cells and gases in the discharge tube system.
